(19) United States
(12) Patent Application Publication
(10) Pub. No.: US 2025/0006045 A1
(43) Pub. Date: Jan. 2, 2025

(54) VEHICLE TRAJECTORY-BASED METHOD FOR SENSING ALLOCATED TIME OF SIGNAL LIGHTS AT INTERSECTION AND ELECTRONIC DEVICE

(71) Applicant: Xiamen Yaxon Zhillan Technology Co., Ltd., Xiamen, Fujian (CN)

(72) Inventors: Yankai TU, Xiamen, Fujian (CN); Xuhui YE, Xiamen, Fujian (CN); Hui LI, Xiamen, Fujian (CN)

(21) Appl. No.: 18/704,763

(22) PCT Filed: Sep. 27, 2022
(86) PCT No.: PCT/CN2022/121719

§ 371 Date: Apr. 25, 2024

(30) Foreign Application Priority Data
Oct. 26, 2021 (CN) 202111249525.5

(51) Int. Cl. G08G 1/01

(52) U.S. Cl. CPC G08G 1/0125; G08G 1/0112

(57) ABSTRACT

The present disclosure provides a vehicle trajectory-based method for sensing allocated time of signal lights at an intersection and an electronic device. The method includes: designating a direction of an intersection, obtaining vehicle trajectory information of vehicles passing through the intersection in the direction, and extracting allocated time estimation parameters for all vehicles from the vehicle trajectory information; filtering the obtained vehicle trajectory information to remove vehicle trajectory information of a vehicle which does not stop at the intersection; calculating a vehicle arrival rate d and a vehicle departure rate a at the intersection in the direction based on the allocated time estimation parameters; selecting vehicle trajectories meeting a>d, and calculating

$$\frac{a}{a - d} ;$$

and performing linear regression analysis on discrete values

$$( {T}_{3} , \frac{a}{a - d} )$$

of the multiple vehicle trajectories of the vehicles passing through the intersection in the direction to obtain allocated time T_{red} for a red light at the intersection in the direction. The method makes it more convenient and intelligent to collect allocated time information of the signal lights at the intersection, and facilitates further application of intelligent transportation and vehicle energy-saving and safety optimization.

### CROSS-REFERENCE TO RELATED APPLICATIONS

This application is a national stage entry of PCT Patent Application PCT/CN2022/121719, filed on Sep. 27, 2022, which claims priority to Chinese Patent Application 202111249525.5, filed on Oct. 26, 2021. PCT Patent Application PCT/CN2022/121719 and Chinese Patent Application 202111249525.5 are incorporated herein by reference.

### TECHNICAL FIELD

The present disclosure relates to the field of data mining, in particular to a vehicle trajectory-based method for sensing allocated time of signal lights at an intersection and an electronic device.

### BACKGROUND

The Internet of vehicles has uploaded a large amount of vehicle trajectory information to a cloud platform. Data mining is performed on the trajectory information to obtain more meaningful information, such as traffic conditions, weather conditions, and driving behavior characteristics. This is conducive to improving user services and improving vehicle energy-saving and safety performance. Allocated time of signal lights at an intersection is important information related to vehicle energy saving and safety. If vehicles can know the allocated time of the signal lights at the intersection in advance, further energy-saving optimization or safety optimization such as early deceleration for passing under a green light can be advantageously performed on the vehicles. However, the allocated time information of the signal lights at the intersection is stored in the traffic management department, so there are difficulties such as non-public data sources, time-consuming data collection, high difficulty in collection, and great changes in data.

### SUMMARY

In view of the above deficiencies in the prior art, an objective of the present disclosure is to provide a method for sensing allocated time of signal lights at an intersection, which can extract allocated time information of the signal lights at the intersection from vehicle trajectory data in the Internet of vehicles.

To achieve the above objective, the present disclosure provides a vehicle trajectory-based method for sensing allocated time of signal lights at an intersection, including:
S1. designating a direction of an intersection, obtaining vehicle trajectory information of vehicles passing through the intersection in the direction, and extracting allocated time estimation parameters for all vehicles from the vehicle trajectory information, where the allocated time estimation parameters include a braking deceleration time point t₁, a stop time point t₂, a stop duration T₃, and a passing duration T₄;
S2. filtering the obtained vehicle trajectory information obtained in step S1 to remove vehicle trajectory information of a vehicle which does not stop at the intersection;
S3. calculating a vehicle arrival rate d and a vehicle departure rate a at the intersection in the direction based on the allocated time estimation parameters; selecting vehicle trajectories meeting a>d, and calculating

$$\frac{a}{a - d} ;$$

and
S4. performing linear regression analysis on allocated time parameters

$$( {T}_{3} , \frac{a}{a - d} )$$

of the multiple vehicle trajectories of the vehicles passing through the intersection in the direction by using an allocated time equation to obtain T_{red} and ε, where T_{red} represents allocated time for a red light, and ε is an error.

$${T}_{3} = \frac{a}{a - d} {T}_{red} + ε$$

Further, the vehicle arrival rate d and the vehicle departure rate a at the intersection in the direction in the step S3 are separately expressed as follows:

$$d = n / ( {t}_{2} - {t}_{1} )$$

$$a = n / {T}_{4}$$

where n is the number of lanes at the intersection in the direction.

A second aspect of the present disclosure further provides an electronic device, including a memory, a processor, and a computer program stored on the memory and executable on the processor, where the processor, when executing the computer program, implements the steps in the vehicle trajectory-based method for sensing allocated time of signal lights at an intersection according to any one of the technical solutions of the first aspect of the present disclosure.

The present disclosure achieves the following technical effects:

The method for sensing allocated time of signal lights at an intersection according to the present disclosure is capable of obtaining allocated time information for a red light in the signal lights at the intersection from trajectory data of numerous vehicles on an Internet-of-vehicle platform by means of data mining, makes it more convenient and intelligent to collect allocated time information of the signal lights at the intersection, and facilitates further application of intelligent transportation and vehicle energy-saving and safety optimization.

### BRIEF DESCRIPTION OF DRAWINGS

FIG. 1 is a flowchart of a vehicle trajectory-based method for sensing allocated time of signal lights at an intersection according to the present disclosure;

FIG. 2 is a schematic diagram showing a travel time distribution of a vehicle passing through a detection line at an intersection; and

FIG. 3 shows a T₃ and a/(a−d) relationship diagram and linear regression analysis of all vehicle trajectories.

### DESCRIPTION OF EMBODIMENTS

To further describe the embodiments, the present disclosure provides the accompanying drawings. These drawings constitute a part of content of the present disclosure and are mainly used to illustrate the embodiments and to explain the operating principles of the embodiments in conjunction with the related description of the specification. With reference to the content, those of ordinary skill in the art can understand other possible embodiments and advantages of the present disclosure.

The present disclosure is now further described in conjunction with the accompanying drawings and specific embodiments.

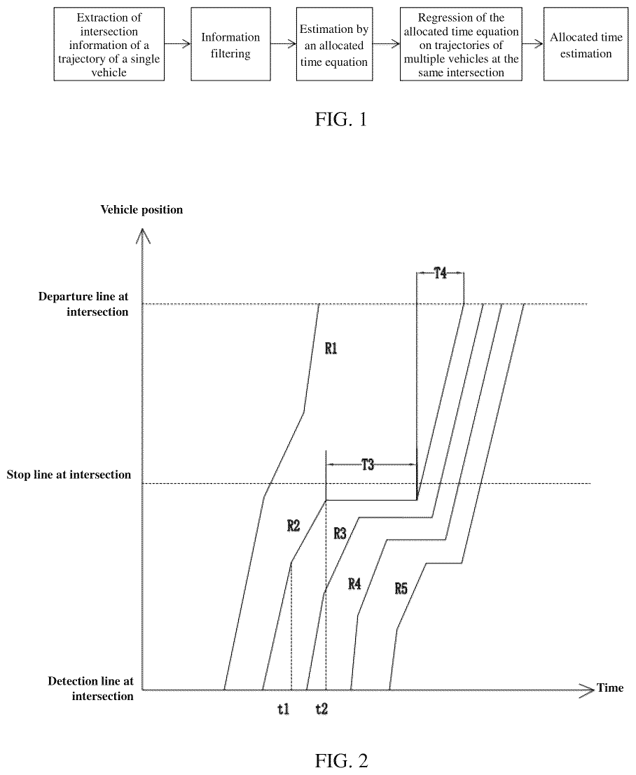

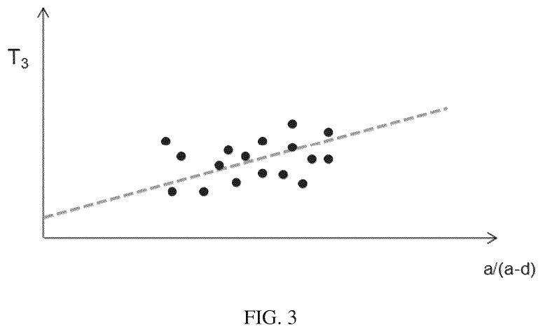

As shown in FIG. 1, FIG. 2, and FIG. 3, the present disclosure provides a vehicle trajectory-based method for sensing allocated time of signal lights at an intersection, including steps below.

The specific process is as follows:

If it is assumed that allocated time information T_{red} for a red light at an intersection in a direction needs to be mined, then a trajectory of a vehicle passing through the intersection in the direction is first retrieved from an Internet-of-vehicles cloud platform, and a section of the trajectory from a detection section at the intersection to a departure section at the intersection is intercepted for analysis.

1. In extraction of intersection information of a trajectory of a single vehicle, a brake signal time point (hereinafter referred to as a braking deceleration time point) t₁ at which the vehicle begins to decelerate before passing through the intersection, a time point (hereinafter referred to as a stop time point) t₂ at which the vehicle completely stops before a stop line for vehicles, a stop duration T₃ (in seconds), and a time point (hereinafter referred to as a passing duration) T₄ (in seconds) from stop to complete passage of the intersection are extracted. The parameters are as shown by examples in FIG. 2 and can be extracted from a trajectory R2.

2. In information filtering, vehicle trajectory data without t₂ and vehicle trajectory data in which T₃ is equal to 0 are filtered. This indicates that when passing through the intersection, the vehicle directly passes without encountering the red light, and it is impossible to extract an allocated time feature for the red light from such data, so filtering is needed. For example, the stop duration T₃ cannot be extracted from a trajectory R1 in FIG. 2.

3. In estimation by an allocated time equation, a vehicle arrival rate d of the vehicle passing through the intersection is estimated and has a formula of d=n/(t₂−t₁), a vehicle departure rate a of the vehicle at the intersection in the direction is estimated and has a formula of a=n/T₄, and both the vehicle arrival rate and the vehicle departure rate are in vehicles/second, where n is the number of lanes at the intersection in the direction, and n is a constant and can be obtained from electronic maps or navigation data.

It can be determined whether there is traffic congestion at the intersection in the direction based on red, yellow, and green data of traffic flow from the cloud platform. If the signal light is green, it indicates that there is no congestion, and vehicle evacuation is faster than vehicle queuing, that is, a>d, such that the next analysis can be conducted.

Based on a traffic flow balance equation d×T₃=a×(T₃−T_{red}), an allocated time equation can be obtained:

$${T}_{3} = \frac{a}{a - d} {T}_{red} .$$

d on the left side of the traffic flow balance equation is an arrival rate at an intersection where a red light is on, and T₃ is a stop time point of a vehicle, so d×T₃ represents the number of vehicles arriving at the intersection when the vehicle stops. T₃−T_{red} on the right side of the traffic flow balance equation represents the stop time point for the vehicle—the allocated time for the red light, that is, an allocated time for which the vehicle can pass, and the allocated time for which the vehicle can pass x the vehicle departure rate a represents the number of vehicles passing through the intersection. Because there is no congestion, results on the left and right sides of the equation are equal.

The allocated time equation

$${T}_{3} = \frac{a}{a - d} {T}_{red}$$

is an idealized equation that may have an error ε in reality, so a real-time allocated time equation is

$${T}_{3} = \frac{a}{a - d} {T}_{red} + ε .$$

4. It can be seen that the equation is a linear equation. A series of values of T₃ and

$$\frac{a}{a - d}$$

can be obtained by repeating the above steps on multiple trajectories from the cloud platform. Regression of a univariate linear equation is performed on these discrete values. After the regression of the univariate linear equation, T_{red} and ε are obtained, such that the allocated time T_{red} for the red light at the intersection in the direction is mined out. As shown in FIG. 3, if

$$\frac{a}{a - d}$$

is used as an abscissa and T₃ is used as an ordinate, each point is an allocated time parameter

$$( {T}_{3} , \frac{a}{a - d} )$$

calculated for a trajectory, a dashed line is an allocated time equation obtained by regression, and a slope of the dashed line is T_{red}.

The method is capable of obtaining allocated time data for a red light in the signal lights at the traffic intersection by means of data mining, has the characteristics of being convenient and intelligent, and facilitates further application of intelligent transportation and vehicle energy-saving and safety optimization.

Based on the same inventive concept, another embodiment of the present disclosure provides an electronic device. The electronic device includes a memory, a processor, and a computer program stored on the memory and executable on the processor, where the processor, when executing the computer program, implements the steps in the method according to any one of the above embodiments of the present application.

Herein, the embodiments are described progressively. Each embodiment focuses on the differences from other embodiments. The same or similar parts in the embodiments may be referred to each other.

It is to be understood by those skilled in the art that an embodiment of the present application can be provided as a method, a device, or a computer program product. Therefore, the embodiment of the present application may be in the form of a pure hardware embodiment, a pure software embodiment, or an embodiment combining software and hardware. Furthermore, the embodiment of the present application may be in the form of a computer program product executed by one or more computer-usable storage media containing computer-usable program codes therein (including but not limited to a magnetic disk memory, a CD-ROM, an optical memory, a semiconductor memory, and the like).

The embodiment of the present application is described with reference to the flowchart and/or the block diagram of the method, the terminal device (system), and the computer program product according to the embodiments of the present application. It is to be understood that each process and/or block in the flowchart and/or the block diagram and combination of processes and/or blocks in the flowchart and/or the block diagram may be implemented by computer program instructions. These computer program instructions may be provided to a general-purpose computer, a special-purpose computer, an embedded processor, or a processor of other programmable data processing terminal equipment so as to give rise to a machine with the result that the instructions executed by the computer or the processor of other programmable data processing terminal equipment give rise to a device that is configured to implement the functions designated by one or more processes in the flowchart and/or one or more blocks in the block diagram.

These computer program instructions may also be stored in a computer-readable memory that can direct the computer or other programmable data processing terminal equipment to function in a particular manner, such that the instructions stored in the computer-readable memory produce a manufactured article including an instruction device that implements the functions designated by one or more processes in the flowchart and/or one or more blocks in the block diagram.

These computer program instructions may also be loaded on the computer or other programmable data processing terminal equipment to perform a series of operation steps on the computer or other programmable terminal equipment to generate the process implemented by the computer, so that the instructions executed by the computer or other programmable terminal equipment provide steps that are used to implement the functions designated by one or more processes in the flowchart and/or one or more blocks in the block diagram.

While the present disclosure has been specifically shown and described with reference to preferred embodiments, it is to be understood by those skilled in the art that various changes in form and details may be made to the present disclosure without departing from the spirit and scope of the present disclosure defined by the appended claims, and all fall within the scope of protection of the present disclosure.

1. A vehicle trajectory-based method for sensing allocated time of signal lights at an intersection, comprising:
S1. designating a direction of the intersection, obtaining vehicle trajectory information of vehicles passing through the intersection in the direction, and extracting allocated time estimation parameters for all of the vehicles from the vehicle trajectory information, wherein the allocated time estimation parameters comprise a braking deceleration time point t₁, a stop time point t₂, a stop duration T₃, and a passing duration T₄;
S2. filtering the vehicle trajectory information obtained in the S1 to remove vehicle trajectory information of a vehicle which does not stop at the intersection;
S3. calculating a vehicle arrival rate d and a vehicle departure rate a at the intersection in the direction based on the allocated time estimation parameters; and selecting vehicle trajectories meeting a>d, and calculating
$$\frac{a}{a - d} ;$$
and
S4. performing linear regression analysis on allocated time parameters
$$( {T}_{3} , \frac{a}{a - d} )$$
of vehicle trajectories of the vehicles passing through the intersection in the direction by using an allocated time equation to obtain T_{red} and ε, wherein T_{red} represents allocated time for a red light, ε is an error, and the stop duration T₃ is calculated as follows:
$${T}_{3} = \frac{a}{a - d} {T}_{red} + ε {.}_{–}$$

2. The vehicle trajectory-based method for sensing allocated time of signal lights at an intersection according to claim 1, wherein the vehicle arrival rate d at the intersection in the direction in the S3 is expressed as follows:
$$d = n / ( {t}_{2} - {t}_{1} )$$
the vehicle departure rate a at the intersection in the direction is expressed as follows:
$$a = n / {T}_{4}$$
wherein n is a number of lanes at the intersection in the direction.

3. An electronic device, comprising a memory, a processor, and a computer program stored on the memory and executable on the processor, wherein the processor, when executing the computer program, implements the vehicle trajectory-based method for sensing allocated time of signal lights at an intersection according to claim 1.

4. An electronic device, comprising a memory, a processor, and a computer program stored on the memory and executable on the processor, wherein the processor, when executing the computer program, implements the vehicle trajectory-based method for sensing allocated time of signal lights at an intersection according to claim 2.
